(19) United States
(12) Patent Application Publication
(10) Pub. No.: US 2024/0002761 A1
(43) Pub. Date: Jan. 4, 2024

(54) HARD SELTZER COMPOSITIONS AND METHODS OF MAKING

(71) Applicant: Anheuser-Busch, LLC, St. Louis, MO (US)

(72) Inventors: Robert NAYLOR, St. Louis, MO (US); Rachel HOOPER, St. Louis, MO (US); John CORRY, St. Louis, MO (US); Carlos CHAPARRO, St. Louis, MO (US)

(21) Appl. No.: 18/037,956

(22) PCT Filed: Dec. 3, 2021
(86) PCT No.: PCT/US21/72730

§ 371 Date: May 19, 2023

Related U.S. Application Data
(60) Provisional application No. 63/120,937, filed on Dec. 3, 2020.
(60) Provisional application No. 63/120,832, filed on Dec. 3, 2020.
(60) Provisional application No. 63/120,958, filed on Dec. 3, 2020.

(51) Int. Cl. C12G 3/025; C12H 3/04

(52) U.S. Cl. CPC C12G 3/025; C12H 3/04

(57) ABSTRACT

Provided herein are methods of making a hard seltzer beverage, wherein a base beverage is filtered using one or more filtration stages. In various embodiments, hard seltzer beverages that are produced using the methods provided herein may be substantially colorless; may have a substantially neutral taste; and/or may have a reduced carbohydrate content. In some embodiments, the methods provided herein enable the production of hard seltzer beverages having one or more of these advantages without significantly reducing the alcohol content of the beverage.

### CROSS REFERENCE TO RELATED APPLICATIONS

This application claims priority to U.S. Provisional Application No. 63/120,832, filed on Dec. 3, 2020; U.S. Provisional Application No. 63/120,937, filed on Dec. 3, 2020, and U.S. Provisional Application No. 63/120,958, filed on Dec. 3, 2020; each of which is incorporated herein by reference in its entirety.

### FIELD

The present disclosure relates to methods of making hard seltzer compositions, for example hard seltzer compositions having reduced (i.e., low or no) carbohydrate content. The present disclosure is also directed to hard seltzer compositions prepared using the methods provided herein.

### BACKGROUND

The market for flavored hard seltzer beverages is rapidly growing, and is projected to continue growing over the next several years. Hard seltzer is typically made by fermenting a sugar solution, typically a solution cane sugar in water, to yield a carbonated, alcoholic base beverage. Flavorings can then be added to the base beverage in order to yield a flavored hard seltzer.

Hard seltzer beverages are appealing to consumers in part because they typically have fewer calories and fewer carbohydrates than beer. Most hard seltzers are also substantially free of gluten, in contrast to beer. There is an increasing desire in the industry for hard seltzer beverages that are free of gluten, have relatively low calories, and that have low or no carbohydrate content. Hard seltzer beverages having less than 0.5 grams of carbohydrates per serving, which may be marketed as “zero carb” beverages in the United States, are particularly desirable.

There is therefore a need in the industry for methods of making a hard seltzer beverage having a reduced carbohydrate content.

### SUMMARY

Provided herein is a method of making a hard seltzer beverage, wherein a base beverage is filtered using one or more filtration stages as described herein.

For example, in one aspect, provided herein is a method of producing a hard seltzer beverage having an increased real degree of fermentation (RDF), the method comprising (a) providing a hard seltzer base beverage; and (b) subjecting at least a fraction of the hard seltzer base beverage to one or more filtration stages selected from the group consisting of nanofiltration (“NF”), carbon filtration (“CF”), reverse osmosis (“RO”), and diafiltration (“DF”), thereby producing a hard seltzer beverage having an RDF of at least about 94.

Also provided herein is a method of producing a hard seltzer beverage having an increased real degree of fermentation (RDF), the method comprising (1) providing a hard seltzer base beverage; (2) subjecting the hard seltzer base beverage or a fraction thereof to a reverse osmosis stage comprising one or more reverse osmosis units, thereby producing a reverse osmosis permeate; and (3) preparing a hard seltzer beverage comprising the reverse osmosis permeate, wherein the hard seltzer beverage has an RDF of at least about 94 and an alcohol content of at least about 2% ABV.

Also provided herein is a method of producing a hard seltzer beverage having an increased real degree of fermentation (RDF), the method comprising (1) providing a hard seltzer base beverage; (2) subjecting the hard seltzer base beverage or a fraction thereof to a carbon filtration stage comprising one or more carbon filtration units, thereby producing a carbon filtration permeate; (3) subjecting the carbon filtration permeate or a fraction thereof to a reverse osmosis stage comprising one or more reverse osmosis units, thereby producing a reverse osmosis permeate; and (4) preparing a hard seltzer beverage comprising at least one beverage fraction selected from the group consisting of the carbon filtration permeate and the reverse osmosis permeate, wherein the hard seltzer beverage has an RDF of at least about 94 and an alcohol content of at least about 2% ABV.

Also provided herein is a method of producing a hard seltzer beverage having an increased real degree of fermentation (RDF), the method comprising (1) providing a hard seltzer base beverage; (2) subjecting the hard seltzer base beverage or a fraction thereof to a nanofiltration stage comprising one or more nanofiltration units, thereby producing a nanofiltration permeate; (3) subjecting the nanofiltration permeate or a fraction thereof to a carbon filtration stage comprising one or more carbon filtration units, thereby producing a carbon filtration permeate; (4) subjecting the carbon filtration permeate or a fraction thereof to a reverse osmosis stage comprising one or more reverse osmosis units, thereby producing a reverse osmosis permeate; and (5) preparing a hard seltzer beverage comprising at least one beverage fraction selected from the group consisting of the nanofiltration permeate, the carbon filtration permeate, and the reverse osmosis permeate, wherein the hard seltzer beverage has an RDF of at least about 94 and an alcohol content of at least about 2% ABV.

Also provided herein is a method of producing a hard seltzer beverage having an increased real degree of fermentation (RDF), the method comprising (1) providing a hard seltzer base beverage; (2) subjecting the hard seltzer base beverage or a fraction thereof to a nanofiltration stage comprising one or more nanofiltration units, thereby producing a nanofiltration permeate; (3) subjecting the nanofiltration permeate or a fraction thereof to a carbon filtration stage comprising one or more carbon filtration units, thereby producing a carbon filtration permeate; (4) subjecting the carbon filtration permeate or a fraction thereof to a reverse osmosis stage comprising one or more reverse osmosis units, thereby producing a reverse osmosis permeate and a reverse osmosis concentrate; (5) subjecting the reverse osmosis concentrate or a fraction thereof to a diafiltration stage comprising one or more diafiltration units, thereby producing a diafiltration permeate; and (6) preparing a hard seltzer beverage comprising at least one beverage fraction selected from the group consisting of the nanofiltration permeate, carbon filtration permeate, reverse osmosis permeate, and diafiltration permeate, thereby producing a hard seltzer beverage having an RDF of at least about 94 and an alcohol content of at least about 2% ABV.

Also provided herein is a method of producing a hard seltzer beverage having an increased real degree of fermentation (RDF), the method comprising (1) providing a hard seltzer base beverage; (2) subjecting at least a fraction of the hard seltzer base beverage to one or more filtration stages selected from the group consisting of nanofiltration, carbon filtration, reverse osmosis, and diafiltration; thereby producing a hard seltzer beverage having an RDF of at least about 94 and an alcohol content of at least about 2% ABV.

In preferred embodiments, the hard seltzer base beverage is prepared via fermentation of an aqueous sugar solution, wherein the aqueous sugar solution comprises, consists essentially of, or consists of cane sugar dissolved in water.

Also provided herein is a hard seltzer beverage prepared according to a method as described herein.

These and other aspects of the present disclosure are described in further detail below.

### DESCRIPTION OF THE DRAWINGS

For a better understanding of certain exemplary embodiments of the present disclosure, reference may be made to the accompanying drawings in which:

FIG. 1 depicts an exemplary embodiment wherein a base beverage is subjected to a reverse osmosis filtration stage.

FIG. 2 depicts an exemplary embodiment wherein the reverse osmosis stage comprises a plurality of reverse osmosis units.

FIG. 3 depicts an exemplary embodiment wherein a base beverage is subjected to a carbon filtration stage and a reverse osmosis filtration stage.

FIG. 4 depicts an exemplary embodiment wherein the carbon filtration stage comprises a plurality of carbon filtration units.

FIG. 5 depicts an exemplary embodiment wherein a base beverage is subjected to a nanofiltration stage, a carbon filtration stage, and a reverse osmosis filtration stage.

FIG. 6A depicts an exemplary embodiment wherein the nanofiltration stage comprises a plurality of nanofiltration units. FIG. 6B depicts an embodiment similar to that of FIG. 6A, but wherein recycle streams are incorporated within the nanofiltration stage.

FIG. 7 depicts an exemplary embodiment wherein a base beverage is subjected to a nanofiltration stage, a carbon filtration stage, a reverse osmosis filtration stage, and a diafiltration stage.

### DETAILED DESCRIPTION

Provided herein are methods of making a hard seltzer beverage, wherein a base beverage is filtered using one or more filtration stages. In various embodiments, hard seltzer beverages that are produced using the methods provided herein may be substantially colorless; may have a substantially neutral taste; and/or may have a reduced carbohydrate content. In some embodiments, the methods provided herein enable the production of hard seltzer beverages having one or more of these advantages without significantly reducing the alcohol content of the beverage.

As used herein, the term “beverage fraction” (or simply “fraction”) refers to all or a portion of the referenced beverage, which may have been subjected to one or more filtration or separation processes as described herein. As a non-limiting example, the term “hard seltzer base beverage or a fraction thereof” refers to the hard seltzer base beverage, to a NF permeate, NF retentate, CF permeate, CF retentate, RO permeate, RO concentrate, DF permeate, or DF concentrate derived directly or indirectly from the hard seltzer base beverage, or to any mixture or combination thereof.

Reduced Carbohydrate Content

As used herein, a “reduced carbohydrate content” means that the hard seltzer beverage contains a reduced content of carbohydrates as compared to the base beverage from which it was derived (i.e., prior to any filtration stages as described herein).

For example, the methods described herein may produce a hard seltzer beverage wherein the carbohydrate content is reduced by at least about 10%, at least about 20%, at least about 30%, at least about 40%, at least about 50%, at least about 60%, at least about 70%, at least about 80%, at least about 90% as compared to the base beverage prior to any filtration stages as described herein.

For example, the hard seltzer beverage may comprise a carbohydrate content of less than about 2.5 grams, less than about 2 grams, less than about 1.5 grams, less than about 1 gram, or less than about 0.5 grams per serving (e.g., per 12 fluid ounce serving).

In particularly preferred embodiments, the hard seltzer beverage comprises a carbohydrate content of less than 0.5 grams of carbohydrates per 12 fluid ounce serving. Equivalently, in particularly preferred embodiments, the hard seltzer beverage comprises a carbohydrate content of less than 0.5 grams of carbohydrates per 355 ml serving.

Real Degree of Fermentation

The methods provided herein may be utilized to produce hard seltzer beverages having a relatively high real degree of fermentation (RDF). In the context of a fermented beverage, the RDF reflects the degree to which sugar present in the wort has been fermented into alcohol. The mouthfeel of a beverage is largely determined by its RDF; beverages having a higher RDF taste “lighter” or “drier,” while beverages having a lower RDF may have a “round” or even “syrupy” mouthfeel.

For example, the methods described herein may produce a hard seltzer beverage having an RDF of at least about 94, at least about 94.5, at least about 95, at least about 95.5, at least about 96, at least about 96.5, at least about 97, at least about 97.5, at least about 98, at least about 98.5, at least about 99, or at least about 99.5.

### Base Beverage

As used herein, the term “base beverage” or “hard seltzer base beverage” refers to a carbonated, alcoholic seltzer. The base beverage may be prepared, for example, via fermentation of a sugar solution. The sugar solution may comprise, for example, cane sugar dissolved in water.

In preferred embodiments, the base beverage is prepared via fermentation of an aqueous sugar solution, wherein the aqueous sugar solution comprises, consists essentially of, or consists of cane sugar dissolved in water. Without being bound to a particular theory, it has been observed that a base beverage prepared via fermentation of a cane sugar solution will have a higher RDF than a base beverage produced using an alternative method (e.g., fermentation of a solution comprising high fructose corn syrup).

Typically, the base beverage has an RDF of greater than about 90 but less than about 98. For example, the base beverage may have an RDF of at least about 90, at least about 91, at least about 92, at least about 93, at least about 94, at least about 95, or at least about 96. The base beverage typically has an RDF of at most about 98, at most about 97.5, or at most about 97. As a non-limiting example, the base beverage may have an RDF of from about 96 to about 97.5.

The base beverage typically has an alcohol content of greater than about 5% and less than about 15% alcohol by volume (ABV). For example, the base beverage may have an alcohol content of from about 2% to about 15%, from about 2% to about 12%, from about 2% to about 11%, from about 2% to about 10%, from about 2% to about 8%, from about 9% to about 12%, or from about 10% to about 11% ABV. The base beverage may have an alcohol content of at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, or at least about 15% ABV. The base beverage may have an alcohol content of at most about 15%, at most about 14%, at most about 13%, at most about 12%, at most about 11%, at most about 10%, at most about 9%, at most about 8%, at most about 7%, at most about 6%, or at most about 5% ABV.

### Conventional Filtration Stages

The processes described herein may optionally comprise one or more conventional yeast filtration stages. The conventional yeast filtration stages may comprise, for example, filtering a beverage fraction comprising, consisting essentially of, or consisting of the base beverage.

Filtration has been used since ancient times to remove suspended solids and sediment from beer and other fermented products. In modern practice, conventional filtration is commonly used to remove yeast and/or reduce the turbidity of beer and other fermented beverages. As used herein, the term “conventional filtration” refers to the use of sieves or other filtration media having a pore size of at least about 0.1 micron, typically ranging up to about 10 microns or greater. Filtration media suitable for conventional filtration of beer and fermented malt beverages are widely available and familiar to those skilled in the art. Conventional filtration techniques may also incorporate centrifugation to remove bulk solids, which is also familiar to those skilled in the art.

Conventional filtration techniques do not significantly change the RDF of fermented beverages. Likewise, conventional filtration techniques do not significantly change the carbohydrate content of fermented beverages.

In embodiments where the process comprises passing the base beverage through one or more conventional filtration stages, the conventional filtration stages typically take place prior to the NF, CF, RO, and/or DF stages discussed in further detail below.

### Reverse Osmosis

The processes described herein may comprise a reverse osmosis (“RO”) stage wherein a beverage fraction is passed through one or more reverse osmosis units to produce a RO permeate and a RO concentrate.

In a reverse osmosis stage as described herein, the beverage fraction entering the reverse osmosis stage is forced through a partially permeable membrane. Typically, membranes used for reverse osmosis are either nonporous or have pores no greater than about 1-2 nanometers in size. Accordingly, in some embodiments, at least about 90% of monovalent ions and organic molecules having a molecular weight greater than about 50 Daltons that enter the reverse osmosis stage are captured by the RO concentrate (i.e., less than about 10% of such ions and molecules pass through to the RO permeate).

The beverage fraction entering the reverse osmosis stage may comprise a base beverage or a fraction thereof, the permeate, concentrate, or retentate of any filtration or separation process, or any mixture or combination thereof. As a non-limiting example, in a preferred embodiment the process comprises a RO stage following a CF stage and/or a NF stage, but prior to any DF stages; in this embodiment, the beverage fraction entering carbon filtration stage may comprise, consist essentially of, or consist of, a CF permeate, a NF permeate, or a combination thereof.

Without being bound to a particular theory, a reverse osmosis stage as described herein has been observed to promote the removal of unfermented carbohydrates from the beverage fraction entering the reverse osmosis stage. The reverse osmosis stage therefore produces a reverse osmosis permeate with a higher RDF than the beverage fraction entering the reverse osmosis stage. Likewise, the reverse osmosis stage produces a reverse osmosis permeate with a lower carbohydrate content than the beverage fraction entering the reverse osmosis stage. Advantageously, the use of reverse osmosis is believed to increase RDF by removing unfermented sugars without removing a substantial portion of alcohol. This is highly desirable in the context of a hard seltzer beverage.

In preferred embodiments, the reverse osmosis stage produces a RO permeate having a higher RDF than the beverage fraction entering the reverse osmosis stage. Likewise, the reverse osmosis stage may produce a RO permeate having a lower carbohydrate content than the beverage fraction entering the reverse osmosis stage. For example, the RDF of the RO permeate may be increased by at least about 0.1, at least about 0.2, at least about 0.3, at least about 0.4, at least about 0.5, at least about 0.6, at least about 0.7, at least about 0.8, at least about 0.9, or at least about 1.0 relative to the RDF of the beverage fraction entering the reverse osmosis stage. In some embodiments, the reverse osmosis stage may increase the RDF of the beverage fraction by an even greater amount, for example, by at least about 1.1, at least about 1.2, at least about 1.3, at least about 1.4, or even at least about 1.5. For example, the reverse osmosis permeate may have an RDF of at least about 94, at least about 94.5, at least about 95, at least about 95.5, at least about 96, at least about 96.5, at least about 97, at least about 97.5, at least about 98, at least about 98.5, at least about 99, or at least about 99.5.

Surprisingly, it has been observed that the RO stage is more efficient at increasing RDF when the beverage fraction enters the one or more reverse osmosis units at a relatively higher temperature. In preferred embodiments, the beverage fraction entering one or more reverse osmosis units (and preferably, the beverage fraction entering each reverse osmosis unit) has a temperature of about 7° C. or greater. For example, the beverage fraction entering one or more reverse osmosis units may have a temperature of from about 1.5° C. to about 18° C., from about 1.5° C. to about 16° C., from about 4° C. to about 16° C., or from about 7° C. to about 13° C. For example, the beverage fraction entering one or more reverse osmosis units may have a temperature of at least about 0° C., at least about 1° C., at least about 2° C., at least about 3° C., at least about 4° C., at least about 5° C., at least about 6° C., at least about 7° C., at least about 8° C., at least about 9° C., or at least about 10° C. Correspondingly, the beverage fraction entering one or more reverse osmosis units (and preferably, the beverage fraction entering each reverse osmosis unit) may have a temperature of 45° F. or greater. For example, the beverage fraction entering one or more reverse osmosis units may have a temperature of from about 35° F. to about 65° F., from about 35° F. to about 60° F., from about 40° F. to about 60° F., or from about 45° F. to about 55° F. For example, the beverage fraction entering one or more reverse osmosis units may have a temperature of at least about 35° F., at least about 40° F., at least about 45° F., or at least about 50° F.

It has also been observed that the RO stage increases RDF more effectively at higher operating pressures, particularly in excess of 6000 kPa. Accordingly, in preferred embodiments, the beverage fraction enters one or more reverse osmosis units (and more preferably, enters each reverse osmosis unit) at a pressure of at least about 6000 kPa. For example, the beverage fraction may enter one or more reverse osmosis units at a pressure of at least about 4750 kPa, at least about 5500 kPa, at least about 5750 kPa, or at least about 6000 kPa. It has been further observed that pressures above about 7000 kPa provide diminishing returns with respect to RDF removal, while increasing the risk of equipment failure. Accordingly, in preferred embodiments, the beverage fraction enters one or more reverse osmosis units at pressure of from about 6000 kPa to about 7000 kPa. Correspondingly, the beverage fraction may enter one or more reverse osmosis units at a pressure of at least about 900 psi. For example, the beverage fraction may enter one or more reverse osmosis units at a pressure of at least about 700 psi, at least about 800 psi, at least about 850 psi, or at least about 900 psi. In preferred embodiments, the beverage fraction may enter one or more reverse osmosis units at pressure of from about 900 psi to about 1000 psi.

Typically, the beverage fraction exits one or more reverse osmosis units (and preferably, exits each reverse osmosis unit) at a pressure of less than about 400 kPa, less than about 350 kPa, less than about 300 kPa, less than about 250 kPa, less than about 200 kPa, less than about 150 kPa, or less than about 100 kPa. For example, the beverage fraction may exit one or more reverse osmosis units at a pressure of from about 10 kPa to about 350 kPa, from about 25 kPa to about 275 kPa, from about 35 kPa to about 200 kPa, or from about 35 kPa to about 125 kPa. Correspondingly, the beverage fraction may exit one or more reverse osmosis units at a pressure of less than about 50 psi, less than about 40 psi, less than about 30 psi, or less than about 20 psi. For example, the beverage fraction may exit one or more reverse osmosis units at a pressure of from about 2 psi to about 50 psi, from about 4 psi to about 40 psi, from about 5 psi to about 30 psi, or from about 5 psi to about 20 psi.

The reverse osmosis stage acts to reduce the carbohydrate content of the beverage fraction that passes through it. In preferred embodiments, the carbohydrate content of the reverse osmosis permeate may be reduced by at least about 10%, at least about 20%, at least about 30%, at least about 40%, at least about 50%, at least about 60%, at least about 70%, at least about 80%, or at least about 90% as compared to the beverage fraction entering the reverse osmosis stage.

The reverse osmosis permeate preferably retains at least about 50%, at least about 60%, at least about 70%, or at least about 80% of the alcohol content of the beverage fraction entering the reverse osmosis stage. For example, the alcohol content of the RO permeate may be at least about 1%, at least about 2%, at least about 3%, at least about 4%, at least about 5%, at least about 6%, at least about 7%, at least about 8%, at least about 9%, at least about 10%, at least about 110, at least about 12%, at least about 13%, at least about 14%, or at least about 15% ABV. Typically, the alcohol content of the RO permeate will less than about 15%, less than about 10%, less than about 8%, less than about 6%, less than about 5%, or less than about 4.5% ABV. For example, the alcohol content of the RO permeate may range from about 2% to about 15%, from about 2% to about 12%, from about 2% to about 11%, from about 2% to about 10%, from about 2% to about 8%, from about 5% to about 15%, from about 8% to about 12%, from about 9% to about 12%, from about 9% to about 11%, or from about 10% to about 110% ABV.

The reverse osmosis stage may comprise a single reverse osmosis unit or a plurality of reverse osmosis units. For example, the reverse osmosis stage may comprise at least two, at least three, at least four, or at least five reverse osmosis units. The plurality of reverse osmosis units may be arranged in series, in parallel, or a combination thereof. Typically, when multiple reverse osmosis units are used, the permeate from each unit will be captured and used as the feed to the following reverse osmosis unit (excepting the final unit, which produces the reverse osmosis permeate that exits the reverse osmosis stage).

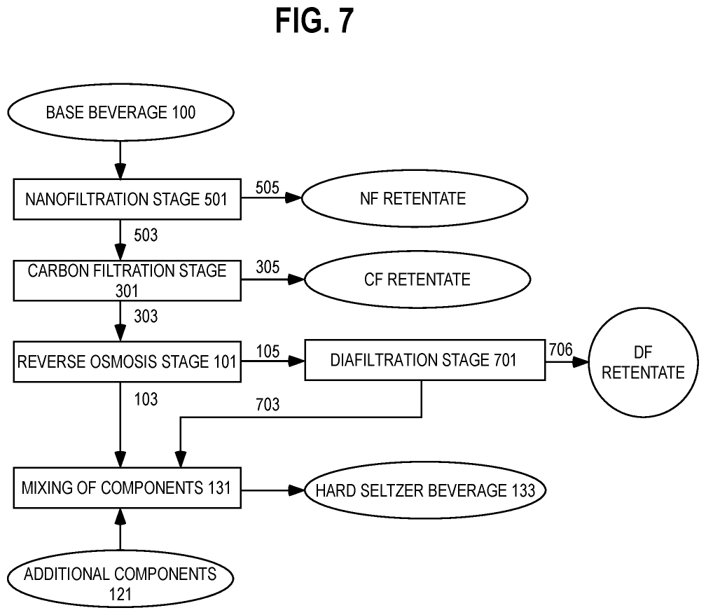

The RO concentrate may be discarded or stored for future use. Alternatively, in some embodiments, as shown in FIG. 7, the RO concentrate may be captured and used as feed for a diafiltration stage, as described in more detail below.

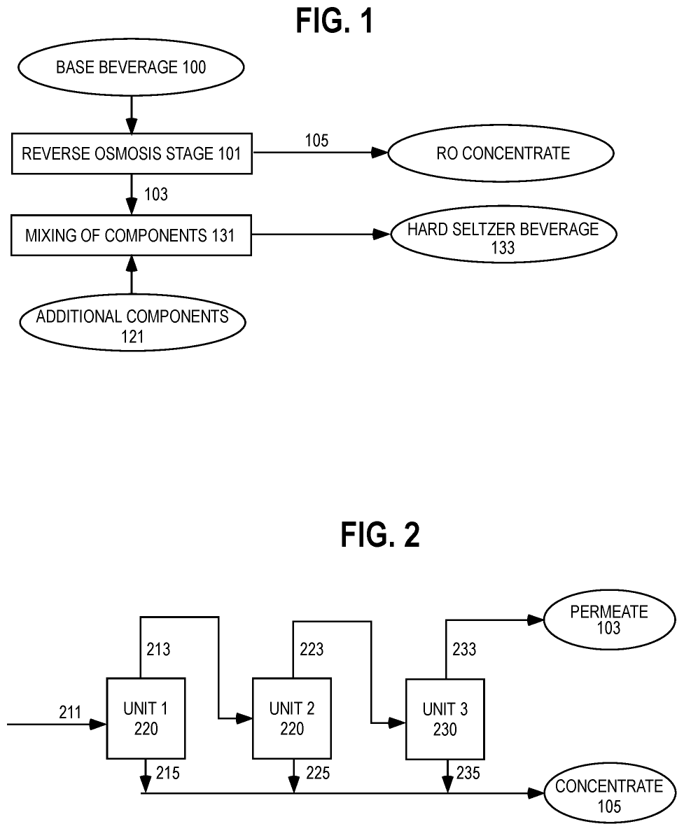

Referring now to the drawings and initially to FIG. 1, in an exemplary embodiment, a base beverage 100 is subjected to a reverse osmosis filtration stage 101, thereby producing a RO permeate 103 and a RO concentrate 105. In the exemplary embodiment shown in FIG. 1, the RO permeate 103 is then combined with one or more additional components 121 (which may comprise one or more natural and artificial flavoring agents, coloring agents, preservatives, stabilizers, or other ingredients as described in further detail below), thereby producing a hard seltzer beverage 133.

FIG. 2 depicts an exemplary embodiment wherein the reverse osmosis stage 101 comprises a plurality of reverse osmosis units (identified with numerals 210, 220, and 230). In this example, the beverage fraction 211 entering the reverse osmosis stage is passed through a first reverse osmosis unit 210, producing a first permeate 213 and a first concentrate 215. The permeate 213 is then passed through a second reverse osmosis unit 220, thereby producing a second permeate 223 and a second concentrate 225. The permeate 223 is then passed through a third reverse osmosis unit 230, thereby producing a third permeate 233 and a third concentrate 235. In this example, permeate 233 exits the reverse osmosis stage as the RO permeate 103. The concentrate streams 215, 225, and 235 are combined and exit the reverse osmosis stage as the RO concentrate 105.

### Carbon Filtration

The processes described herein may comprise a carbon filtration (“CF”) stage wherein a beverage fraction is passed through one or more carbon filtration units to produce a CF permeate and a CF retentate.

The beverage fraction entering the carbon filtration stage may comprise a base beverage or a fraction thereof, the permeate or retentate of any filtration or separation process, or any mixture or combination thereof. As a non-limiting example, in a preferred embodiment the process comprises a CF stage following the NF stage, but prior to any RO, and/or DF stages; in this embodiment, the beverage fraction entering carbon filtration stage may comprise, or consist essentially of, a NF permeate. As a further example, the process may comprise an initial CF stage prior to any NF, RO, and/or DF stages; in this embodiment, the beverage fraction entering the carbon filtration stage may comprise, or consist essentially of, a base beverage as described above.

In a carbon filtration stage as described herein, the beverage fraction entering the carbon filtration stage may be passed through one or more filtration units comprising activated carbon (e.g., carbon granules or a porous carbon substrate).

In preferred embodiments, the carbon filtration stage produces a CF permeate having a higher RDF than the beverage fraction entering the carbon filtration stage. Likewise, the carbon filtration stage may produce a CF permeate having a lower carbohydrate content than the beverage fraction entering the carbon filtration stage. For example, the RDF of the CF permeate may be increased by at least about 0.1, at least about 0.2, at least about 0.3, at least about 0.4, at least about 0.5, at least about 0.6, at least about 0.7, at least about 0.8, at least about 0.9, or at least about 1.0 relative to the RDF of the beverage fraction entering the carbon filtration stage. The carbon filtration permeate may have an RDF of at least about 94, at least about 94.5, at least about 95, at least about 95.5, at least about 96, at least about 96.5, at least about 97, at least about 97.5, at least about 98, at least about 98.5, at least about 99, or at least about 99.5.

In preferred embodiments, the beverage fraction entering one or more carbon filtration units (and preferably, the beverage fraction entering each carbon filtration unit) has a temperature of less than about 6° C. For example, the beverage fraction entering one or more carbon filtration units may have a temperature of less than about 5° C., less than about 4° C., less than about 3° C., less than about 2° C., less than about 1° C., or less than about 0.5° C. Typically, the beverage fraction entering one or more carbon filtration units is at least about 0° C. Correspondingly, the beverage fraction entering one or more carbon filtration units preferably has a temperature of less than about 42° F. For example, the beverage fraction entering one or more carbon filtration units may have a temperature of less than about 40° F., less than about 38° F., or less than about 35° F.

In preferred embodiments, the beverage fraction enters one or more carbon filtration units (and more preferably, enters each carbon filtration unit) at pressure of about 100 kPa. For example, the beverage fraction may enter one or more carbon filtration units at a pressure of at least about 30 kPa, at least about 40 kPa, at least about 50 kPa, at least about 60 kPa, at least about 70 kPa, at least about 80 kPa, at least about 90 kPa, or at least about 100 kPa. The beverage fraction may enter one or more carbon filtration units at a pressure of at most about 200 kPa, at most about 180 kPa, at most about 160 kPa, at most about 140 kPa, at most about 130 kPa, at most about 120 kPa, at most about 110 kPa, or at most about 100 kPa. Correspondingly, the beverage fraction may enter one or more carbon filtration units at pressure of about 15 psi. For example, the beverage fraction may enter one or more carbon filtration units at a pressure of at least about 5 psi, at least about 8 psi, at least about 10 psi, at least about 12 psi, or at least about 15 psi. The beverage fraction may enter one or more carbon filtration units at a pressure of at most about 30 psi, at most about 25 psi, at most about 20 psi, at most about 18 psi, or at most about 15 psi.

In preferred embodiments, the carbon filtration stage does not substantially reduce the alcohol content of the beverage fraction that passes through it. For example, the CF permeate preferably retains at least about 50%, at least about 60%, at least about 70%, at least about 80%, at least about 90%, at least about 95%, at least about 98%, or at least about 99% of the alcohol content of the beverage fraction entering the CF stage. For example, the alcohol content of the CF permeate may be at least about 1%, at least about 2%, at least about 3%, at least about 4%, at least about 5%, at least about 6%, at least about 7%, at least about 8%, at least about 9%, at least about 10%, at least about 110, at least about 12%, at least about 13%, at least about 14%, or at least about 15% ABV. Typically, the alcohol content of the CF permeate will less than about 15%, less than about 10%, less than about 8%, less than about 6%, less than about 5%, or less than about 4.5% ABV. For example, the alcohol content of the CF permeate may range from about 2% to about 15%, from about 2% to about 12%, from about 2% to about 110, from about 2% to about 10%, from about 2% to about 8%, from about 5% to about 15%, from about 8% to about 12%, from about 9% to about 12%, from about 9% to about 11%, or from about 10% to about 110% ABV.

The carbon filtration stage may comprise a single carbon filtration unit or a plurality of carbon filtration units. For example, the carbon filtration stage may comprise at least two, at least three, at least four, or at least five carbon filtration units. The plurality of carbon filtration units may be arranged in series, in parallel, or a combination thereof. Typically, when multiple carbon filtration units are used, the CF permeate from each unit will be captured and used as the feed to the following CF unit (excepting the final unit, which produces the CF permeate that exits the nanofiltration stage).

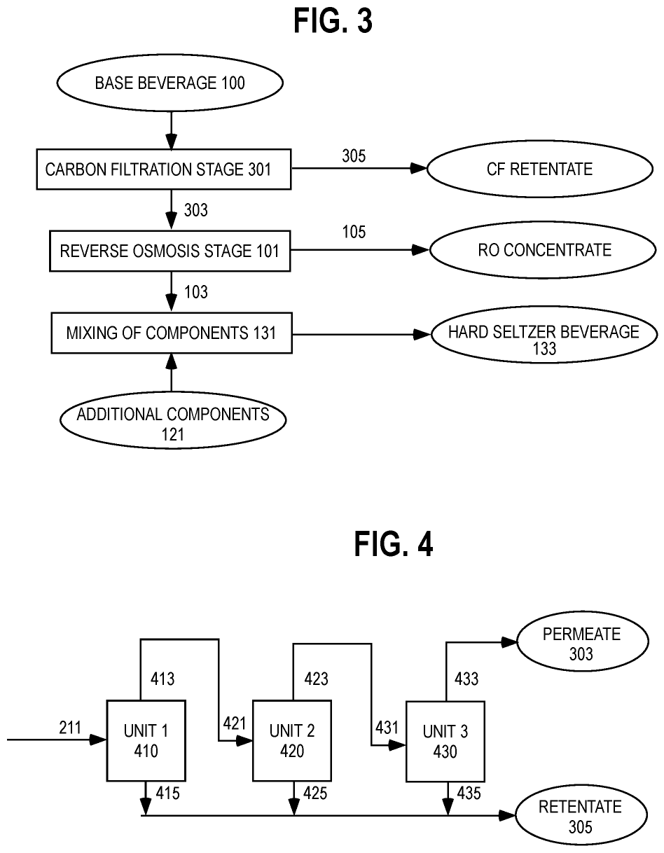

Referring now to the drawings, FIG. 3 depicts an embodiment similar to that of FIG. 1, but further comprising a carbon filtration stage 301 prior to reverse osmosis stage 101. Carbon filtration stage 301 produces a CF retentate 305, which is discarded, and a CF permeate 303, which is then used as the input to reverse osmosis stage 101.

FIG. 4 depicts an exemplary embodiment wherein the carbon filtration stage 301 comprises a plurality of carbon filtration units (identified with numerals 410, 420, and 430). In this example, the beverage fraction 411 entering the carbon filtration stage is passed through a first carbon filtration unit 410, producing a first permeate 413 and a first retentate 415. The permeate 413 is then is then incorporated into the input stream 421 to the second carbon filtration unit 420, thereby producing a second permeate 423 and a second retentate 425. The permeate 423 is then is then incorporated into the input stream 431 to the third carbon filtration unit 430, thereby producing a third permeate 433 and a third retentate 435. In this example, permeate 433 exits the carbon filtration stage as the CF permeate 303. The retentate streams 415, 425, and 435 are combined and exit the carbon filtration stage as the CF retentate 305.

### Nanofiltration

The processes described herein may comprise a nanofiltration (“NF”) stage wherein a beverage fraction is passed through one or more nanofiltration membrane units to produce an NF permeate and an NF retentate.

The beverage fraction entering the nanofiltration stage may comprise a base beverage or a fraction thereof, the permeate or retentate of any filtration or separation process, or any mixture or combination thereof. As a non-limiting example, in a preferred embodiment the process comprises an initial NF stage where the base beverage is filtered prior to any CF, RO, and/or DF stages; in this embodiment, the beverage fraction entering the nanofiltration stage may comprise, or consist essentially of, a base beverage as described above.

In a nanofiltration stage as described herein, the beverage fraction entering the nanofiltration stage is forced through a partially permeable membrane. Typically, membranes used for nanofiltration have a pore size of from about 1 nanometer to about 10 nanometers.

Without being bound to a particular theory, the nanofiltration stage is believed to increase the RDF of the beverage fraction, as described in further detail below.

In preferred embodiments, the beverage fraction entering one or more nanofiltration units (and more preferably, the beverage fraction entering each nanofiltration unit) has a temperature of approximately 4.5° C. For example, the beverage fraction entering one or more nanofiltration units may have a temperature of at least about 0° C., at least about 1° C., at least about 2° C., at least about 3° C., at least about 4° C., or at least about 4.5° C. The beverage fraction entering one or more nanofiltration units may have a temperature of at most about 8° C., at most about 7° C., at most about 6° C., at most about 5.5° C., at most about 5° C., or at most about 4.5° C. As non-limiting examples, the beverage fraction entering one or more nanofiltration units may have a temperature from about 0° C. to about 10° C., from about 0° C. to about 7° C., from about 1.5° C. to about 7° C., or from about 3° C. to about 6° C. Correspondingly, the beverage fraction entering one or more nanofiltration units may have a temperature of approximately 40° F. For example, the beverage fraction entering one or more nanofiltration units may have a temperature of from about 32° F. to about 50° F., from about 32° F. to about 45° F., from about 35° F. to about 45° F., or from about 38° F. to about 42° F.

In preferred embodiments, the beverage fraction enters one or more nanofiltration units (and more preferably, enters each nanofiltration unit) at pressure of about 4000 kPa. For example, the beverage fraction may enter one or more nanofiltration units at a pressure of at least about 1000 kPa, at least about 1500 kPa, at least about 2000 kPa, at least about 2500 kPa, at least about 3000 kPa, at least about 3500 kPa, at least about 3750 kPa, or at least about 4000 kPa. The beverage fraction may enter one or more nanofiltration units at a pressure of at most about 8000 kPa, at most about 7000 kPa, at most about 6000 kPa, at most about 5500 kPa, at most about 5000 kPa, at most about 4500 kPa, at most about 4250 kPa, or at most about 4000 kPa. Correspondingly, the beverage fraction may enter one or more nanofiltration units at pressure of about 600 psi. For example, the beverage fraction may enter one or more nanofiltration units at a pressure of at least about 200 psi, at least about 300 psi, at least about 400 psi, at least about 500 psi, at least about 550 psi, or at least about 600 psi. The beverage fraction may enter one or more nanofiltration units at a pressure of at most about 1000 psi, at most about 900 psi, at most about 800 psi, at most about 750 psi, at most about 700 psi, at most about 650 psi, or at most about 600 psi.

Typically, the beverage fraction exits one or more nanofiltration units (and more preferably, exits each nanofiltration unit) at a pressure of less than about 350 kPa, less than about 275 kPa, less than about 200 kPa, or less than about 125 kPa. For example, the beverage fraction may exit one or more nanofiltration units at a pressure of from about 10 kPa to about 350 kPa, from about 25 kPa to about 275 kPa, from about 35 kPa to about 200 kPa, or from about 35 kPa to about 125 kPa. Correspondingly, the beverage fraction may exit one or more nanofiltration units at a pressure of less than about 50 psi, less than about 40 psi, less than about 30 psi, or less than about 20 psi. For example, the beverage fraction may exit one or more nanofiltration units at a pressure of from about 2 psi to about 50 psi, from about 4 psi to about 40 psi, from about 5 psi to about 30 psi, or from about 5 psi to about 20 psi.

In preferred embodiments, the nanofiltration stage produces a NF permeate having a higher RDF than the beverage fraction entering the nanofiltration stage. Likewise, the nanofiltration stage may produce a NF permeate having a lower carbohydrate content than the beverage fraction entering the nanofiltration stage. For example, the RDF of the NF permeate may be increased by at least about 0.1, at least about 0.2, at least about 0.3, at least about 0.4, at least about 0.5, at least about 0.6, at least about 0.7, at least about 0.8, at least about 0.9, or at least about 1.0 relative to the RDF of the beverage fraction entering the nanofiltration stage. In some embodiments, the nanofiltration stage may increase the RDF of the beverage fraction by an even greater amount, for example, by at least about 1.1, at least about 1.2, at least about 1.3, at least about 1.4, or even at least about 1.5. For example, the nanofiltration permeate may have an RDF of at least about 94, at least about 94.5, at least about 95, at least about 95.5, at least about 96, at least about 96.5, at least about 97, at least about 97.5, at least about 98, at least about 98.5, at least about 99, or at least about 99.5.

In preferred embodiments, the NF stage does not substantially reduce the alcohol content of the beverage fraction that passes through it. For example, the NF permeate preferably retains at least about 50%, at least about 60%, at least about 70%, at least about 80%, at least about 90%, at least about 95%, at least about 98%, or at least about 99% of the alcohol content of the beverage fraction entering the NF stage. For example, the alcohol content of the NF permeate may be at least about T %, at least about 2%, at least about 3%, at least about 4%, at least about 5%, at least about 6%, at least about 7%, at least about 8%, at least about 9%, at least about 10%, at least about 110, at least about 12%, at least about 13%, at least about 14%, or at least about 15% ABV. Typically, the alcohol content of the NF permeate will less than about 15%, less than about 10%, less than about 8%, less than about 6%, less than about 5%, or less than about 4.5% ABV. For example, the alcohol content of the NF permeate may range from about 2% to about 15%, from about 2% to about 12%, from about 2% to about 110%, from about 2% to about 10%, from about 2% to about 8%, from about 5% to about 15%, from about 8% to about 12%, from about 9% to about 12%, from about 9% to about 1%, or from about 10% to about 11% ABV.

The nanofiltration stage may comprise a single nanofiltration unit, as shown for example in FIG. 2. Alternatively, the nanofiltration stage may comprise a plurality of nanofiltration units, as shown for example in FIG. 3. For example, the nanofiltration stage may comprise at least two, at least three, at least four, or at least five nanofiltration units. The plurality of nanofiltration units may be arranged in series, in parallel, or a combination thereof. Typically, when multiple nanofiltration units are used, the permeate from each unit will be captured and used as the feed to the following NF unit (excepting the final unit, which produces the NF permeate that exits the nanofiltration stage).

The NF retentate may be discarded or stored for future use. Alternatively, in some embodiments, the nanofiltration stage may include a recycle system wherein the NF retentate from each unit is captured and incorporated into an NF recycle stream. The NF recycle stream or a portion thereof may then be incorporated into the feed stream for one or more of the NF units.

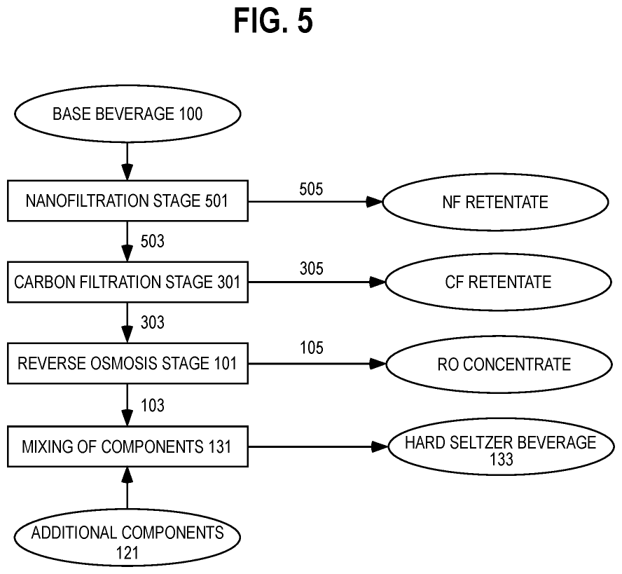

Referring now to the drawings, FIG. 5 depicts an embodiment similar to that of FIG. 3, but further comprising a nanofiltration stage 501 prior to carbon filtration stage 301. Nanofiltration stage 501 produces a NF retentate 505, which is discarded, and a NF permeate 503, which is then used as the input to carbon filtration stage 301.

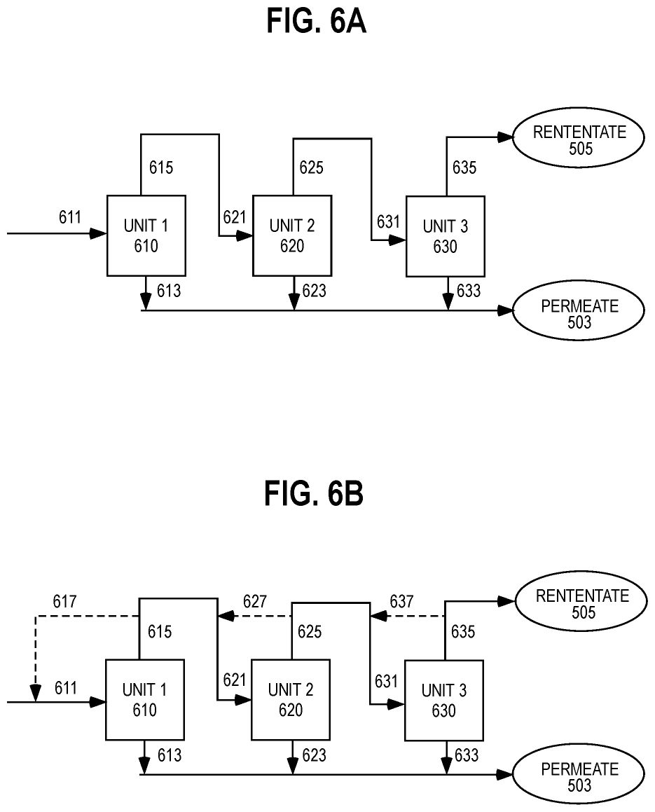

FIG. 6A depicts an exemplary embodiment wherein the nanofiltration stage 501 comprises a plurality of nanofiltration units (identified with numerals 610, 620, and 630). In this example, the beverage fraction 611 entering the nanofiltration stage is passed through a first nanofiltration unit 610, producing a first permeate 613 and a first retentate 615. The retentate 615 is then incorporated into the input stream 621 to the second nanofiltration unit 620, which produces a second permeate 623 and a second retentate 625. The retentate 625 is then incorporated into the input stream 631 to the third nanofiltration unit 630, which produces a third permeate 633 and a third retentate 635. In this example, retentate 635 exits the nanofiltration stage as the NF retentate 505. The permeate streams 615, 625, and 635 are combined and exit the nanofiltration stage as the NF permeate 503.

FIG. 6B depicts an embodiment similar to that of FIG. 6A, but wherein recycle streams are incorporated within the nanofiltration stage. Specifically, in this embodiment, a portion of the first retentate 615 is captured as a first recycle stream 617 and incorporated into beverage fraction 611 entering the first nanofiltration unit 610. Likewise, a portion of the second retentate 625 is captured as a second recycle stream 627 and incorporated into the input stream 621 entering the second nanofiltration unit 620; and a portion of the third retentate 635 is captured as a third recycle stream 637 and incorporated into the input stream 631 entering the third nanofiltration unit 630.

### Diafiltration

The processes described herein may further comprise a diafiltration (“DF”) stage wherein a beverage fraction is passed through one or more diafiltration membrane units to produce a DF permeate and a DF concentrate.

When the process comprises a reverse osmosis stage, a RO concentrate is produced. The RO concentrate comprises a significant amount of alcohol, typically 7.5 to 25 percent by weight. It has been discovered that a diafiltration stage can be incorporated to recover the alcohol from the RO concentrate. For example, in one embodiment, the beverage fraction entering the DF stage comprises the RO concentrate, optionally mixed with water.

The diafiltration stage may utilize the same type of filter media as employed in the reverse osmosis stage. The temperature and pressure of the beverage fractions entering and exiting the one or more diafiltration membrane units may be selected as described above with respect to the reverse osmosis stage.

As an illustrative example, FIG. 7 depicts an embodiment similar to that of FIG. 5, but further comprising a diafiltration stage 701. Rather than discarding the RO concentrate 105, as in the previously illustrated embodiments, the process of FIG. 7 incorporates RO concentrate 105 as the input to diafiltration stage 701. The diafiltration stage produces a DF concentrate 705, which is discarded, and a DF permeate 703, which is incorporated into the mixing step 131 and, therefore, into hard seltzer beverage 133.

The diafiltration stage may comprise a single diafiltration unit. Alternatively, the diafiltration stage may comprise a plurality of diafiltration units. For example, the diafiltration stage may comprise at least two, at least three, at least four, or at least five diafiltration units. As a non-limiting example, when multiple diafiltration units are used, the DF permeate from each unit will be captured and used as the feed to the following DF unit.

The DF concentrate may be discarded or stored for future use. Alternatively, in some embodiments, the DF stage may include a recycle system wherein the DF concentrate (also referred to as the concentrate) from each unit is captured and incorporated into an DF recycle stream. The DF recycle stream or a portion thereof may then be incorporated into the feed stream for one or more of the DF units. The diafiltration stage may utilize co-courant flow or counter-courant flow.

### Preparation of a Hard Seltzer Beverage

The processes described herein may further comprise a beverage preparation stage wherein a hard seltzer beverage is prepared. The hard seltzer beverage comprises at least one filtered beverage fraction selected from the group consisting of the NF permeate, the CF permeate, the RO permeate, and the DF permeate. In some embodiments, the hard seltzer beverage consists essentially of, or consists of, one or more filtered beverage fractions as described herein. In other embodiments, the filtered beverage fraction(s) may be combined with water and/or one or more additional components to produce the hard seltzer beverage.

For example, the beverage preparation stage may comprise combining the reverse osmosis permeate with one or more additional components. Non-limiting examples of additional components that may be added following the filtration stages described herein include natural and artificial flavoring agents, coloring agents, preservatives, and stabilizers.

As a further example, the beverage preparation stage may comprise combining the reverse osmosis permeate with (1) one or more beverage fractions selected from the group consisting of the NF permeate, the CF permeate, and the DF permeate, and (2) one or more additional components as described above.

### Hard Seltzer Beverages

Hard seltzer beverages prepared using the methods provided herein are also within the scope of the present disclosure. In preferred embodiments, the hard seltzer beverage is a flavored seltzer that further comprises one or more natural or artificial flavors.

The hard seltzer beverage may have an RDF of at least about 94, at least about 94.5, at least about 95, at least about 95.5, at least about 96, at least about 96.5, at least about 97, at least about 97.5, at least about 98, at least about 98.5, at least about 99, or at least about 99.5.

The hard seltzer beverage typically has an alcohol content of greater than about 5% and less than about 15% alcohol by volume (ABV). For example, the hard seltzer beverage may have an alcohol content of from about 2% to about 15%, from about 2% to about 12%, from about 2% to about 11%, from about 2% to about 10%, from about 2% to about 8%, from about 9% to about 12%, or from about 10% to about 11% ABV. The hard seltzer beverage may have an alcohol content of at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, or at least about 15% ABV. The hard seltzer beverage may have an alcohol content of at most about 15%, at most about 14%, at most about 13%, at most about 12%, at most about 11%, at most about 10%, at most about 9%, at most about 8%, at most about 7%, at most about 6%, or at most about 5% ABV.

In preferred embodiments, the hard seltzer beverage has an alcohol content that is least about 50%, at least about 60%, at least about 70%, at least about 80%, at least about 90%, at least about 95%, at least about 98%, or at least about 99% of the alcohol content of the base beverage (on an ABV basis).

In particularly preferred embodiments, the hard seltzer beverage comprises a carbohydrate content of less than 0.5 grams of carbohydrates per 12 fluid ounce serving. Equivalently, in particularly preferred embodiments, the hard seltzer beverage comprises a carbohydrate content of less than 0.5 grams of carbohydrates per 355 ml serving.

Other objects and features will be in part apparent and in part pointed out hereinafter.

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that several objects of the disclosure are achieved and other advantageous results attained.

It will be understood that certain features and sub-combinations of the present embodiments are of utility and may be employed without reference to other features and sub-combinations. Since many possible embodiments of the present disclosure may be made without departing from the spirit and scope of the present disclosure, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present disclosure.

As is evident from the foregoing description, certain aspects of the present disclosure are not limited by the particular details of the examples illustrated herein, and it is therefore contemplated that other modifications and applications, or equivalents thereof, will occur to those skilled in the art. The terms “may,” “can,” “having,” “including,” and similar terms as used in the foregoing specification are used in the sense of “optional” or “may include” and not as “must” or “required.”

Many changes, modifications, variations and other uses and applications of the present constructions will, however, become apparent to those skilled in the art after considering the specification and the accompanying drawings. All such changes, modifications, variations and other uses and applications which do not depart from the spirit and scope of the disclosure are deemed to be covered by the disclosure which is limited only by the claims which follow.

As various changes could be made in the above products and methods without departing from the scope of the disclosure, it is intended that all matter contained in the above description shall be interpreted as illustrative and not in a limiting sense.

1. A method of producing a hard seltzer beverage having an increased real degree of fermentation (RDF), the method comprising:
(1) providing a hard seltzer base beverage;
(2) subjecting the hard seltzer base beverage or a fraction thereof to a reverse osmosis stage comprising one or more reverse osmosis units, thereby producing a reverse osmosis permeate; and
(3) preparing a hard seltzer beverage comprising the reverse osmosis permeate, wherein the hard seltzer beverage has an RDF of at least about 94 and an alcohol content of at least about 2% ABV.

2. The method of claim 1 wherein the RDF of the reverse osmosis permeate is greater than the RDF of the hard seltzer base beverage.

3. The method of claim 2 wherein the RDF of the reverse osmosis permeate is increased by at least about 0.1, at least about 0.2, at least about 0.3, at least about 0.4, at least about 0.5, at least about 0.6, at least about 0.7, at least about 0.8, at least about 0.9, or at least about 1.0 relative to the RDF of the beverage fraction entering the reverse osmosis stage.

4. The method of claim 2 wherein the RDF of the reverse osmosis permeate is increased by at least about 1.1, at least about 1.2, at least about 1.3, at least about 1.4, or at least about 1.5 relative to the RDF of the beverage fraction entering the reverse osmosis stage.

5. The method of claim 2 wherein the RDF of the reverse osmosis permeate is at least about 94.5, at least about 95, at least about 95.5, at least about 96, at least about 96.5, at least about 97, at least about 97.5, at least about 98, at least about 98.5, at least about 99, or at least about 99.5.

6. The method of claim 1 wherein the reverse osmosis permeate retains at least about 50%, at least about 60%, or at least about 70% of the alcohol content of the beverage fraction entering the reverse osmosis stage.

7. The method of claim 1 wherein the beverage fraction entering one or more reverse osmosis units has a temperature of at least about 4° C., at least about 5° C., at least about 6° C., at least about 7° C., at least about 8° C., at least about 9° C., or at least about 10° C.

8. The method of claim 1 wherein the beverage fraction entering one or more reverse osmosis units has a temperature of from about 4° C. to about 16° C., or from about 7° C. to about 13° C.

9. The method of claim 1 wherein the beverage fraction entering one or more reverse osmosis units has a pressure of least about 4750 kPa, at least about 5500 kPa, at least about 5750 kPa, or at least about 6000 kPa.

10. The method of claim 1 wherein the beverage fraction entering one or more reverse osmosis units has a pressure of from about 6000 kPa to about 7000 kPa.

11. The method of claim 1 wherein the reverse osmosis stage comprises two or more reverse osmosis units.

12. A method of producing a hard seltzer beverage having an increased real degree of fermentation (RDF), the method comprising:
(1) providing a hard seltzer base beverage;
(2) subjecting the hard seltzer base beverage or a fraction thereof to a carbon filtration stage comprising one or more carbon filtration units, thereby producing a carbon filtration permeate;
(3) subjecting the carbon filtration permeate or a fraction thereof to a reverse osmosis stage comprising one or more reverse osmosis units, thereby producing a reverse osmosis permeate; and
(4) preparing a hard seltzer beverage comprising at least one beverage fraction selected from the group consisting of the carbon filtration permeate and the reverse osmosis permeate,
wherein the hard seltzer beverage has an RDF of at least about 94 and an alcohol content of at least about 2% ABV.

13. The method of claim 12 wherein the RDF of the carbon filtration permeate is greater than the RDF of the hard seltzer base beverage.

14. The method of claim 13 wherein the RDF of the carbon filtration permeate is increased by at least about 0.1, at least about 0.2, at least about 0.3, at least about 0.4, at least about 0.5, at least about 0.6, at least about 0.7, at least about 0.8, at least about 0.9, or at least about 1.0 relative to the RDF of the beverage fraction entering the carbon filtration stage.

15. The method of claim 14 wherein the RDF of the carbon filtration permeate is at least about 94.5, at least about 95, at least about 95.5, at least about 96, at least about 96.5, at least about 97, at least about 97.5, at least about 98, at least about 98.5, at least about 99, or at least about 99.5.

16. The method of claim 12 wherein the beverage fraction entering one or more carbon filtration units has a temperature of less than about 6° C., less than about 5° C., less than about 4° C., less than about 3° C., less than about 2° C., less than about 1° C., or less than about 0.5° C.

17. The method of claim 12 wherein the beverage fraction entering one or more carbon filtration units has a temperature of from about 4° C. to about 16° C., or from about 7° C. to about 13° C.

18. The method of claim 12 wherein the carbon filtration permeate retains at least about 80%, at least about 90%, at least about 95%, at least about 98%, or at least about 99% of the alcohol content of the beverage fraction entering the carbon filtration stage.

19. The method of claim 12 wherein the beverage fraction entering one or more carbon filtration units has a pressure of at least about 30 kPa, at least about 40 kPa, at least about 50 kPa, at least about 60 kPa, at least about 70 kPa, at least about 80 kPa, at least about 90 kPa, or at least about 100 kPa.

20. The method of claim 12 wherein the beverage fraction entering one or more carbon filtration units has a pressure of at most about 200 kPa, at most about 180 kPa, at most about 160 kPa, at most about 140 kPa, at most about 130 kPa, at most about 120 kPa, at most about 110 kPa, or at most about 100 kPa.

21. The method of claim 12 wherein the carbon filtration stage comprises two or more carbon filtration units.

22.-48. (canceled)
